(19) United States
(12) Patent Application Publication
(10) Pub. No.: US 2015/0059650 A1
(43) Pub. Date: Mar. 5, 2015

(54) PET BED WITH CUSHIONED NON-SKID OUTER SURFACE AND A METHOD FOR MAKING A PET BED

(71) Applicant: Jessica Lea Kent, Weaverville, NC (US)

(72) Inventor: Jessica Lea Kent, Weaverville, NC (US)

(21) Appl. No.: 14/016,329

(22) Filed: Sep. 3, 2013

(51) Int. Cl. A01K 1/035

(52) U.S. Cl. CPC A01K 1/0353
USPC 119/28.5

(57) ABSTRACT

A layered pad and a process for making a layered pad are provided. The pad includes an intermediate layer with a predetermined shape, the intermediate layer having a closed construction a topping layer overlying one side of the intermediate layer, and a floor layer overlying an opposite side of the intermediate layer. One or both of the topping layer and the floor layer has a substantially non-skid surface portion facing away from the intermediate layer. A securing arrangement maintains the topping layer and the floor layer at a maximum predetermined spacing from one another as measured along a line passing through the intermediate layer and intersecting the topping layer and the floor layer.

### BACKGROUND OF THE INVENTION

Pet beds, mats, and pads provide a comfortable resting place for an animal to He on and these have been made of various shapes, designs and materials. U.S. Pat. No. 3,902,456 to David discloses a donut-shaped pet cushion while other patents disclose designs comprising canvas stretched over metal frame, hammocks, and animal shapes.

Pet beds, mats, and pads can be useful for ameliorating the often uncomfortable properties of floor surfaces on which pets sit or lie. For example, the flooring in many kennels is concrete, wood, vinyl or any other hard surface, which is often uncomfortable for animals. The lack of a soft resting place can aggravate arthritic conditions and other joint problems, including hip dysplasia. The lack of a soft resting place can also cause calluses and wear the hair off of elbows, which is a particular problem for show dogs and their owners.

One solution to this problem is to fill the animal bed with filler providing cushioning for the pet thereby eliminating the discomfort and potent calluses and physical wear on the pet. Commonly, these are the pillow type beds that are filled with a variety of material. For example, cedar shavings are a natural filling that has the added benefit of repelling parasites such as fleas that may be living on the pet. However, some pets are allergic to such fillers requiring the purchase of a different bed. Another common filling is a polyester filling that is initially soft and comfortable but quickly goes either flat or lumpy leaving the pet in an uncomfortable bed. Most of these beds are inexpensive, and as a result they typically are made from low-grade exterior fabrics. Holes tend to wear quickly in this fabric and eventually the filling falls out the holes, or the bed becomes so soiled that it requires disposal and replacement.

Higher quality filled beds are not only of a higher quality fabric but often have a zipper or other closure means that allows the filling be changed and the cover to be washed. Unfortunately, this process can be very challenging as the filling can be extremely messy as well as the filling has potential to foul and eventually ruin the expensive zippers or other closure means. Again, the pet owner has the expense of purchasing a new animal bed.

While the above-noted pet beds undoubtedly will serve the purpose which they were designed, none is regarded as accomplishing the purpose in an optimum manner, in terms of comfort and attractiveness. Accordingly, there is still a need for an animal support pad that further improves the ease of use and comfort of such products.

Also, in addition to pet bed or pet cushion products, support pads and mats have been offered for people to enjoy the benefit of a cushioned rest spot at many indoor and outdoor locations. However, such support pads generally do not provide any beneficial therapeutic effects such as, for example the beneficial therapeutic effect offered by finger pressure therapy of promoting blood circulation and easing muscles aches or kinks. Accordingly, there is still a need for a support pad for people that further improves the ease of use and comfort of such products.

### SUMMARY OF THE INVENTION

It is, therefore, an object of the present invention to provide an animal support pad upon which a dog, a cat, or other animal can comfortably rest. Moreover, it is an object of the present invention to provide an animal support pad that is convenient to store and convenient to carry.

Additionally, it is an object of the present invention is to provide a bed pad, an automobile seat pad, a pillow or a similar cushionlike item having the effects of promoting blood circulation and easing sore muscles similar to those of spot or finger pressure therapy.

Another object of the present invention is to provide a pad, an automobile seat pad, a pillow or a similar cushionlike item which offers a non-skid surface that promotes stability of the pad on a surface.

In accordance with one aspect of the present invention, there is provided a layered pad. The pad includes an intermediate layer with a predetermined shape, the intermediate layer having a closed cell construction, a topping layer overlying one side of the intermediate layer, a floor layer overlying an opposite side of the intermediate layer, at least one of the topping layer and the floor layer having a substantially non-skid surface portion facing away from the intermediate layer, and a securing arrangement that maintains the topping layer and the floor layer at a maximum predetermined spacing from one another as measured along a line passing through the intermediate layer and intersecting the topping layer and the floor layer.

In accordance with another aspect of the present invention, there is provided a layered pad made by a process.

In accordance with a further aspect of the present invention, there is provided a pet bed.

### BRIEF DESCRIPTION OF THE DRAWINGS

For a more complete understanding of the embodiments of the present invention, reference is now made to the following descriptions taken in connection with the accompanying drawings in which:

FIG. 1 is a top perspective view of one embodiment of the layered pad of the present invention;

FIG. 2 is a front exploded elevation& sectional view the layered pad shown in FIG. 1;

FIG. 3 is a front exploded elevational sectional view of an alternate version of the layered pad having a single thickness intermediate layer; and

FIG. 4 is a front exploded elevational sectional view of the layered pad shown in FIG. 1.

### DETAILED DESCRIPTION OF AN EMBODIMENT

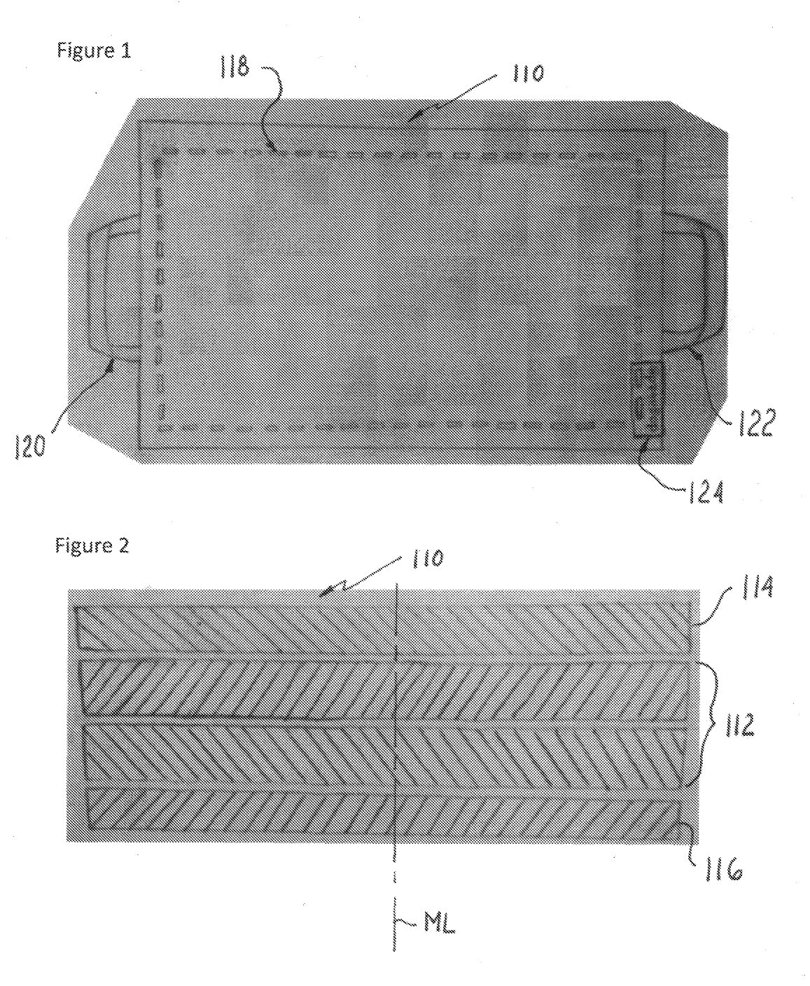

One aspect of the present invention relates to a layered pad suitable for use by itself, or as part of, a pet bed or a pet cushion product and suitable for use by itself, or as part of a support pad or mat product that permits a person to enjoy the benefit of a cushioned rest spot at many indoor and outdoor locations. As seen in FIG. 1, which is a top plan view of one embodiment of the layered pad of the present invention, and FIG. 2, which is a front exploded elevational sectional view of the layered pad shown in FIG. 1, a layered pad 110 includes an intermediate layer 112 with a predetermined shape, the intermediate layer having a closed cell construction, a topping layer 114 overlying one side of the intermediate layer 112, a floor layer 116 overlying an opposite side of the intermediate layer 112, and a securing arrangement 116. At least one of the topping layer 114 and the floor layer 116 has, and, preferably, both of the topping layer 114 and the floor layer 116 have, a substantially non-skid surface portion facing away from the intermediate layer 112. The securing arrangement 118 maintains the topping layer 114 and the floor layer 116 at a maximum predetermined spacing from one another as measured along a line ML passing through the intermediate layer 112 and intersecting the topping layer 114 and the floor layer 116.

It is to be understood that the layered pad 110 can be configured in a number of different configurations and shapes that are nearly unlimited and any configuration or shape desired is to expressly be understood as falling within the scope of the invention.

With regard to the topping layer 114 and the floor layer 116, the preferred type of construction is in the form of, or in simulation of a yoga mat. A yoga mat is considered to be a mat that can be bent or rolled and that has at least one surface portion characterized by dimples undulations, projections, or the like that provide such surface portion with improved non-skid properties. Various fabric materials may be used for the topping layer 114 and the floor layer 116, the preferred type of material being washable and, if desired, decorative fabrics can be used that are readily available in a variety of colors at reasonable prices. The selected materials are preferably substantially hypo-allergenic and not prone to pilling, crumbling, or discoloration.

From the foregoing, it will be apparent that the layered pad 110 of the present invention is of a novel and attractive construction which not only contributes to the comfortableness and accessibility of the pad for pets or people, but also makes practical the economical fabrication of such pads in a rationalized assembly process including, as desired, the use of fabrication jigs to cutting components to final assembly size and supporting components during in-process assembly with other components and semi-automatic or automatic stitching stations. In this regard, the present invention also provides layered pad made by the process of providing an intermediate layer with a predetermined shape, the intermediate layer having a closed cell construction; disposing a topping layer such that the topping layer is on one side of the inner layer when the layered pad is completed, disposing a floor layer such that the floor layer is an opposite side of the inner layer when the layered pad is completed, at least one of the topping layer and the floor layer having a substantially non-skid surface portion facing away from the intermediate layer when the layered pad is complete and securing the inner layer at a position intermediate the topping layer and the floor layer so that the intermediate layer remains in a location that is intermediate the topping layer and the floor layer when the layered pad is completed.

When a user lays his or her body on the support pad, the combinatory cushioning effects and flexibility of the topping layer 114, the floor layer 116, and the intermediate layer 112 will promote beneficial blood circulation with a slight movement of the shoulder, back, waist or legs of the user. Since both topping layer 114 and the floor layer 116 each have a non-skid surface, a user may use the layered pad 110 either right side up or upside down as desired.

The intermediate layer 112 can be comprised of an open-cell foam or a closed-cell foam and can additionally include another type of foam or other type of filler material that supplies a normally expansive force to the intermediate layer. Preferably, the intermediate layer 112 is formed of closed cell polymeric foams pads such as known pads formed of a foamed copolymer of ethylene and vinyl acetate, also known as ethylene-vinyl acetate (EVA). The particular closed cell foam pads can be selected based upon considerations of economy weight, durability and stored volume.

The closed cell structure is resistant to water absorption and also reduces heat loss. As shown in FIG. 2, for example, the intermediate layer 112 can be comprised of a pair of closed cell polymeric foams pads.

Each closed cell polymeric foams pad can thus be made of a polymer material, most preferably an ethylene-vinyl acetate/polyethylene copolymer, (EVA) of a density preferably between 1 and 25 pounds per cubic foot, more preferably between 1 and 12 pounds per cubic foot and most preferably between 1 and 4 pounds per cubic foot. Each closed cell polymeric foam pad may be formed by a molding process, most preferably by thermoforming. For example, a thermoforming process can be used that involves heating a thermoplastic polymer slab workpiece having substantially uninterrupted upper and lower surfaces to a temperature above that determined to be the temperature at which the material begins to become plastic (formable) but is not fluid. The heated workpiece is then placed in a press having upper and lower molds. The press is then dosed to engage the polymer workpiece between the upper and lower molds and with sufficient force to cause the heated pad to flow and conform to the mold patterns. The pad is then cooled and the closed cell polymeric foams pad is removed.

Although in the present invention EVA foam is preferred, other thermoplastic foams, such as polyethylene foams, cross-linked polyethylene foams, vinyl foams, and the like may be used. Further, foams with uniform cell size and uniform cell distribution and uniform density are preferred. In the broader range, foams with variations in cell size, density distribution, cell distribution, and foam/film and foam/fabric laminates may be used.

The intermediate layer 112 is preferably formed of a pair of independently movable parallelepiped structures of closed-cell foam that are arranged in substantially overlapping relationship to one another. This arrangement may promote air flow between the two closed-cell foam parallelepiped structures that beneficial reduces the accumulation of undesirable moisture that would otherwise negatively promote mold or other unwanted conditions. Additionally, natural or synthetic material may be distributed between the two closed-cell foam parallelepiped structures themselves and/or between the two closed-cell foam parallelepiped structures and the topping layer 114 of the floor layer 116. Such a distributed material may be selected from a group consisting of natural material such as wood shavings, bamboo chips, natural organic materials, synthetic organic or inorganic materials such as plastics, ceramics, rubbers and processed materials, and a combination of one or more materials mentioned above.

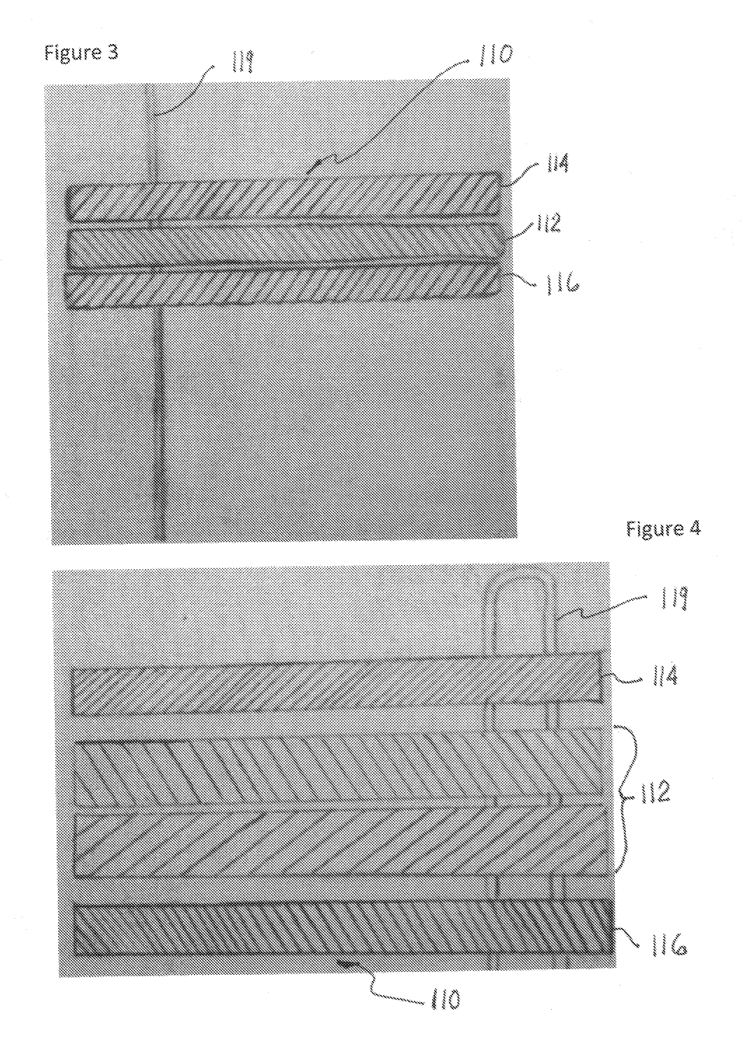

The topping layer 114 and the floor layer 116 are each preferably parallelepiped structures of equal dimensions and each one of the topping layer 114 and the floor layer 116 having a greater width and a greater length than the two closed-cell foam parallelepiped structures of the intermediate layer 112. One assembly sequence for assembling the layered pad 110 includes the steps of arranging the two closed-cell foam parallelepiped structures of the intermediate layer 112 in substantially overlapping relationship to one another with the lowermost one of the two closed-cell foam parallelepiped structures of the intermediate layer 112 resting on the inner facing surface of the floor layer 116. Thereafter, the topping layer 114 is disposed on top of the two closed-cell foam parallelepiped structures of the intermediate layer 112 with the topping layer 114 and the floor layer 116 in substantially overlapping relationship to one another. The securing arrangement 118 in the form of a continuous loop of stitching 119 is then stitched through those overhanging edge portions of the topping layer 114 and the floor layer 116 that extend outwardly in a widthwise sense or a lengthwise sense from the two closed-cell foam parallelepiped structures of the intermediate layer 112. FIG. 3, which is a front exploded elevational sectional view of an alternate version of the layered pad having a single thickness intermediate layer, shows one manner in which the stitching 119 can extend through the floor layer 116, the intermediate layer 112, and the topping layer 114.

As seen in FIG. 4, which is a front exploded elevational sectional view of the layered pad shown in FIG. 1, in the one embodiment of the layered pad shown in FIG. 1, the continuous loop of stitching 119 follows a path along which it cyclically extends from the floor layer 116 through the two closed-cell foam parallelepiped structures of the intermediate layer 112 to then extend through the topping layer 144 and the stitching then reverses direction to thereafter extend again through the topping layer 114 through the two closed-cell foam parallelepiped structures of the intermediate layer 112, and again through the floor layer 116.

Once the loop of stitching 119 is drawn tight, the overhanging edge portions of the topping layer 114 and the floor layer 116 are brought into contact with one another and the two closed-cell foam parallelepiped structures of the intermediate layer 112 are thus retained between the topping layer 114 and the floor layer 116. It can be understood that this method of securing the components of the layered pad 110 together ensure that the topping layer 114 and the floor layer 116 are maintained at a maximum predetermined spacing from one another as measured along the line ML passing through the intermediate layer 112 and intersecting the topping layer 114 and the floor layer 116.

A head handle 120 formed of a web strap material is attached via sewing to one end of the layered pad 110 and a tail handle 122 formed of a web strap material is attached via sewing to another end of the layered pad 110. Other enhancements beyond the handles 120, 122 can be provided as desired including, for example, a graphic indicia 124 displayed on the topping layer 114 or a mold or bacteria resistant coating applied to the outer surfaces of the layered pad 110.

The teachings of this application are not to be construed as being limited to any particular layered pad or process for making a layered pad. While various embodiments of the invention have been described and illustrated herein, it is to be distinctly understood that the invention is not limited thereto, but may be otherwise variously embodied and practiced within the scope of the following claims.

what is claimed is:

1. A layered pad made by the process of:
providing an intermediate layer with a predetermined shape, the intermediate layer having a closed cell construction;
disposing a topping layer such that the topping layer is on one side of the intermediate layer when the layered pad is completed;
disposing a floor layer such that the floor layer is an opposite side of the intermediate layer when the layered pad is completed, at least one of the topping layer and the floor layer having a substantially non-skid surface portion facing away from the intermediate layer when the layered pad is completed; and
securing the inner layer at a position intermediate the topping layer and the floor layer so that the intermediate layer remains in a location that is intermediate the topping layer and the floor layer when the layered pad is completed.

2. A layered pad comprising
an intermediate layer with a predetermined shape, the intermediate layer having a closed cell construction;
a topping layer overlying one side of the intermediate layer;
a floor layer overlying an opposite side of the intermediate layer, at least one of the topping layer and the floor layer having a substantially non-skid surface portion facing away from the intermediate layer; and
a securing arrangement that maintains the topping layer and the floor layer at a maximum predetermined spacing from one another as measured along a line passing through the intermediate layer and intersecting the topping layer and the floor layer.

3. A pet bed comprising:
a pair of closed-cell foam parallelepiped structures in substantially overlapping relationship to one another,
a topping layer overlaying one side of the pair of closed-cell foam parallelepiped structures;
a floor layer overlying an opposite side of the pair of closed-cell foam parallelepiped structures, at least one of the topping layer and the floor layer having a substantially non-skid surface portion facing away from the pair of closed-cell foam parallelepiped structures; and
an extent of stitching interconnecting the topping layer and the floor layer.
